(19) United States
(12) Patent Application Publication
(10) Pub. No.: US 2022/0041127 A1
(43) Pub. Date: Feb. 10, 2022

(54) VEHICLE SAFETY DEVICE FOR PROVIDING PEDESTRIAN PROTECTION

(71) Applicant: Autoliv Development AB, Vargarda (SE)

(72) Inventor: Erik Rydsmo, Sollebrunn (SE)

(21) Appl. No.: 17/275,950

(22) PCT Filed: Sep. 11, 2019
(86) PCT No.: PCT/EP2019/074216

§ 371 Date: Mar. 12, 2021

(30) Foreign Application Priority Data
Sep. 14, 2018 (FR) 1858268

(51) Int. Cl. B60R 21/38; F15B 15/19

(52) U.S. Cl. CPC B60R 21/38; F15B 15/19

(57) ABSTRACT

The invention relates to a thrust member for a pedestrian protection device of a motor vehicle, comprising: —a fixed body which is arranged to be fixed on the vehicle, —a piston which is movable relative to the fixed body between a rest position and a deployed position, —a pyrotechnic actuator which is arranged to move the piston from the rest position to the deployed position. The invention is characterized in that the piston is crimped to the fixed body to be held in the rest position.

The present invention generally relates to an automobile safety device for providing pedestrian protection. Typically, such a safety device comprises a thrust or lift member used to quickly move a hood of the vehicle in the event of collision with a pedestrian, in order to significantly move the hood away from the members of the engine. Thus, the hood can be deformed in contact with the pedestrian without immediately coming into contact with the members of the engine, which would cause an abrupt deceleration for the pedestrian.

Document JP2000033850 discloses a thrust or lift member of an automobile safety device for providing pedestrian protection, with a piston that is elastically fitted onto a fixed body in order to retain the piston on the enclosure before the device is fired. Such an assembly can have a risk of inadvertent detachment and requires strict manufacturing tolerances, resulting in high manufacturing costs.

Document WO2008026423 discloses a thrust or lift member of an automobile safety device for providing pedestrian protection, with a piston that can slide in a bore. However, the disclosed mounting can have parasitic movements before operation, which can cause clicking noises. Furthermore, because of the large size of the piston, manufacturing costs can be considerable in order to ensure low tolerances and dispersions.

One aim of the present invention is to address the disadvantages of the prior art mentioned hereinbefore, and in particular, first of all, to propose a thrust member that comprises components that are simple to manufacture, while offering guaranteed integrity before operation and an absence of clicking noise.

To that end, a first aspect of the invention relates to a thrust member for a motor vehicle pedestrian protection device, comprising:
a fixed body arranged to be fixed on the vehicle,
a piston, which is movable relative to the fixed body between a rest position and a deployed position,
a pyrotechnic actuator, arranged to move the piston from the rest position to the deployed position,
   characterized in that the piston is crimped to the fixed body to be held in the rest position.

According to the above embodiment, the piston is crimped to the fixed body. Thus, the assembly is robust with no risk of inadvertent detachment, while still making it possible to use components that are simple to manufacture. A member is understood in the present application as being a part of a machine or of a device, having a specific function, in other words a subassembly of a plurality of components that in the present case provides the function of thrusting or lifting the hood. Crimping is typically accomplished by plastic and irreversible deformation of material of a first part, pressed into a recessed portion or against relief of a second part. The piston is typically made of metal.

Advantageously, the piston is a part that is able to move in translation, slidably engaged with the fixed body. In practice, a sliding pivot connection with the fixed body can be considered, and the movement of the piston will still be translational even if the piston could turn on itself. According to one embodiment, the piston can be a female part mounted and crimped to the fixed body. Indeed, the piston itself can form an external female part of the device (which for example covers the fixed body when it is in rest position), and still be called piston due to the translational movement, typically vertical in order to raise a vehicle hood in a pedestrian protection application.

Advantageously, the piston crimped in the rest position comprises at least one portion of crimped wall, seated on a support portion of the fixed body and sloped relative to a direction of movement of the piston. The support portion is typically a face of a groove or of a projection of the fixed body, oriented transversely relative to the direction of movement of the piston. The groove and/or the projections are defined so that once crimped, the piston cannot be moved along the axis of movement of the piston.

Advantageously, the piston has a circumference, and wherein the piston is crimped over the full circumference thereof or only by segments. Crimping over the full circumference makes it possible to maximize the end-of-travel retention. Circumferential crimping can be obtained by a multiple-jaw crimping machine or by deep rolling. Conversely, crimping by segments makes it possible to better control or minimize the force to discharge the piston. If crimping by segments is preferred, 3 segments make it possible to ensure good guidance once the piston leaves the housing thereof.

Advantageously, the fixed body comprises at least one groove, and wherein the piston, crimped in the rest position, comprises a wall portion arranged in the groove, following a plastic deformation. In particular, the plastic deformation is produced after the insertion of the piston onto the fixed body.

Advantageously, the fixed body comprises at least one projection, and wherein the piston, crimped in the rest position, comprises a wall portion seated on the projection, following a plastic deformation. Plastic deformation is understood as a permanent deformation of the material. The projection can be one or a series of localized protrusion(s).

Advantageously, the fixed body comprises:
a crimping interface, arranged to allow a crimping for retaining the piston in the rest position thereof,
a stop interface, arranged to form an end-of-travel stop for the piston in order to define the deployed position,
   and wherein the end-of-travel stop has a clearance dimension for the piston that is greater than a clearance dimension of the crimping interface.

In practice, the aforementioned clearance dimension corresponds to an outside diameter or to an outside dimension of the interface concerned, then forming a portion of the fixed body that is in contact with an inner surface of the piston when said piston is in rest position. Consequently, a first force is necessary to make the crimped portion of the piston pass above the clearance dimension of the crimping interface, and a second force would be necessary to make the crimped portion of the piston pass above the end-of-travel clearance dimension, which enables the piston to be stopped in a robust manner at the end of travel.

Alternatively, the fixed body comprises:
a crimping interface, designed to allow a crimping for retaining the piston in the rest position thereof,
a stop interface, arranged to form an end-of-travel stop for the piston in order to define the deployed position,
   and wherein the end-of-travel stop has a clearance dimension for the piston that is less than or equal to a clearance dimension of the crimping interface. In order to guarantee good crimping and proper cylindricity of the piston, the outside dimension of the groove (or of the projections) is greater than or equal to the dimension of the stop. By contrast, the dimension or diameter of the bottom of the crimping interface remains less than the dimension or diameter of the stop.

Advantageously, the fixed body comprises a thinner portion between the crimping interface and the stop interface, the thinner portion having a clearance dimension less than the clearance dimension of the crimping interface. In other words, the fixed body has a smaller cross-section between the crimping interface and the stop interface. Moreover, once out of its housing, the piston will resume a shape compatible with a gasket fitted between the fixed body and the piston.

Alternatively, the fixed body comprises a thinner portion between the crimping interface and the stop interface, the thinner portion having a clearance dimension greater than the clearance dimension of the crimping interface. According to this embodiment, better guidance is obtained because once out of the housing, the piston will be supported on the surface due to the elastic return.

In other words, the piston comprises a crimped portion that ensures that the piston is maintained in rest position on the fixed body.

Consequently, the crimped portion, once the piston is out of the rest position thereof, will participate in guiding the piston during its travel toward the deployed position. In particular, the crimped portion resumes its initial shape after leaving the crimping interface and provides guidance of the piston by sliding or being supported on the thinner portion.

When the piston has arrived in deployed position, once again it is the crimped portion that will interact with the fixed body, in particular with the stop interface, in order to stop the travel of the piston and stop it in deployed position.

In other words, the invention relates to a thrust member for a motor vehicle pedestrian protection device, comprising:
a fixed body arranged to be fixed on the vehicle,
a piston, which is movable relative to the fixed body between a rest position and a deployed position,
a pyrotechnic actuator, arranged to move the piston from the rest position to the deployed position,
   characterized in that the piston comprises a crimped portion that ensures that the piston is maintained in the rest position on the fixed body, and preferably the crimped portion forms guide means between the piston and the fixed body during displacement of the piston from the rest position to the deployed position.

Advantageously, the fixed body comprises a positioning portion, arranged between the crimped portion and the stop portion, and arranged to guide and position the piston during a crimping operation onto the fixed body.

Advantageously, the fixed body comprises elastic holding means arranged to engage with the piston and hold it in the deployed position. For example, an elastically biased tab can be provided to brace against the piston once said piston is in deployed position, so as to prevent any return movement.

Advantageously, the pyrotechnic actuator comprises a pyrotechnic igniter, crimped, overmolded or clipped onto the fixed body.

Advantageously, the fixed body comprises a base and a slot arranged in the base to form a clearance for a connection element of the pyrotechnic actuator.

Advantageously, the slot has a depth adapted to completely receive the connection element

Advantageously, the thrust member comprises a gasket arranged between the piston and the fixed body.

Advantageously, the piston is formed by a shell. Such an embodiment allows a simple design of the fixed body, which is simply topped by the piston, said piston being crimped into a groove of the fixed body in order to remain in rest position in a robust manner.

Advantageously, the shell is a stamped part.

A second aspect of the invention is a pedestrian protection device for a vehicle, comprising at least one thrust member according to the first aspect of the invention in order to form a lift member of a hood.

A last aspect of the invention relates to a motor vehicle comprising at least one pedestrian protection device according to the second aspect of the invention.

In the present application, reference is made to a piston, which term here designates a part that is moved from a rest position to a deployed position. The piston can be a part having a cylindrical geometry, for example circular in cross section, but a cylinder of non-circular cross-section can be envisaged (it is understood that a cylinder has a surface the generatrices whereof are parallel to each other and follow the perimeter of a closed base curve, which base curve may or may not be circular). Non-cylindrical shapes may be considered. The piston can be a part that covers the fixed body, but it can also be envisaged that the piston is housed within the fixed body.

It is understood that all the technical characteristics hereinabove can be combined together or dissociated from each other as long as there is no technical incoherence or incompatibility.

Other features and advantages of the present invention will be seen more clearly from the following detailed description of an embodiment of the invention provided by way of a non-limiting example and illustrated by the appended drawings, wherein:

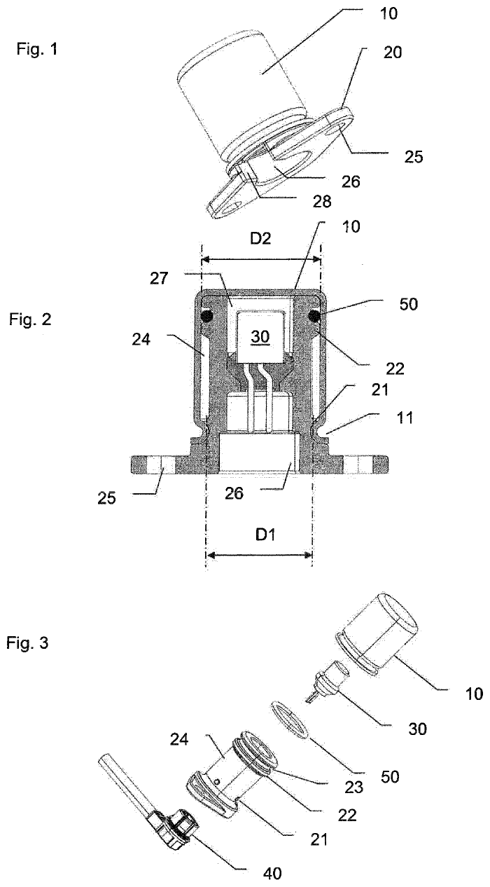

FIG. 1 depicts an isometric view of a thrust member according to the invention;

FIG. 2 depicts a cross-section of the thrust member from FIG. 1;

FIG. 3 depicts an exploded view of the thrust member from FIG. 1, as well as a connector enabling the control of the firing thereof.

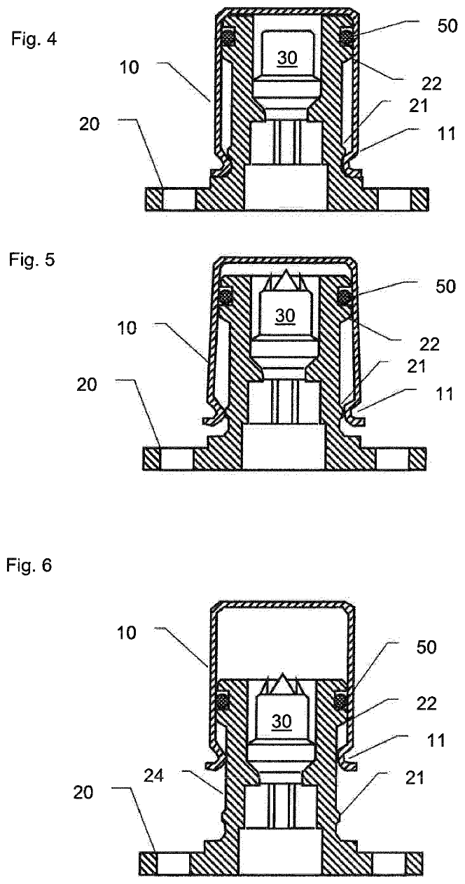

FIG. 4 depicts the thrust member from FIG. 2, prior to the operation thereof,

FIG. 5 depicts the thrust member from FIG. 2, at the beginning of operation,

FIG. 5 depicts the thrust member from FIG. 2, in operation.

FIG. 1 depicts a view in perspective of a thrust member according to the invention, which comprises a piston 10, and a fixed body 20 arranged to be permanently fixed on a motor vehicle. To that end, attachment holes 25 are provided in the fixed body 20, in order typically to attach the thrust member under a vehicle hood in order to raise the hood several centimeters to allow a deformation of the hood in the event of collision with a pedestrian.

To enable this displacement, the thrust member comprises a pyrotechnic igniter 30, visible in FIGS. 2 and 3, housed in a bore 27 of the fixed body 20 and which can generate combustion gases in response to a firing signal (typically an electric current sent by the vehicle's circuit board by means of a connector 40 visible in FIG. 3), in order to pressurize the bore 27, and then push the piston 10 upwards, which piston is generally shell- or cap-shaped.

Indeed, FIG. 2 depicts the piston 10 in a rest position, but under the effect of pressurizing gases from the pyrotechnic igniter 30, the piston 10 can be displaced towards the top of FIG. 2 in order to occupy a deployed position.

The pyrotechnic igniter 30 can be crimped, held by a ring force-fitted or overmolded onto the fixed body 20 and a gasket 50 is provided between the piston 10 and the fixed body 20. Prior to deployment, it is important to guarantee that the piston 10 remains in its rest position in order to ensure for example that it cannot be disengaged from the fixed body 20 before being mounted on a vehicle, and/or that no clicking noise will be generated inadvertently.

To that end, the invention proposes crimping the piston 10 in the rest position thereof to the fixed body 20, as shown in FIG. 2.

In particular, a crimping interface is provided with at least one projecting part 21 and a recessed part into which a crimping portion 11 of the piston 10 can be pressed in a definitive manner (with plastic deformation). The projecting portion 21 and the recessed portion of the fixed body 20 can be formed a crimping groove, or else by protrusions or domes as can be seen in FIG. 3.

In any case, the crimped portion 11 of the piston 10 is pressed against a sloped wall of the fixed body 20 in such a way that the rest position is ensured in a robust manner.

The invention also proposes installing an end-of-travel portion 22 on the fixed body 20, onto which the piston 10 (particularly the crimped portion 11) will abut, in order to define the deployed position. In detail, the projecting part 21 has an outside diameter D1 that defines a first clearance dimension, and the end-of-travel interface 22 has an outside diameter D2 that defines a second clearance dimension, and advantageously D2 is greater than D1, which makes it possible to ensure stopping in position. However, it can be provided that D1 is greater than or equal to D2 to ensure good crimping.

The stopping of the piston 10 is guaranteed by the fact that the crimped portion 11 should be deformed by a certain amount in order to “pass above” the projecting part 21, but should be further deformed in order to do the same with the end-of-travel interface 22. As the volume then available to the gases from the pyrotechnic igniter has increased, the thrust force exerted on the piston 10 in the deployed position is weaker than in the rest position, which ensures that the crimped part 11 (somewhat deformed after having gone past the protruding part 21) will not be deformed to go past the end-of-travel interface 22 (because the force is less, and the deformation should be greater).

In order not to hinder or impede the movement of the piston 10 between the rest position thereof and the deployed position thereof, a thinner portion 24 can be provided, arranged between the crimping interface and the end-of-travel interface 22, in order to guarantee minimum friction and good guidance between the piston 10 and the fixed body 20 during deployment. In other words, the fixed body 20 has at the thinner portion a diameter smaller than the diameter D1. However, a diameter of the thinner portion 24 can be provided that is at least equal to that of the portion of fixed body in contact with the crimped portion 11 of the piston 10 in rest position, in other words, for example, the bottom of groove diameter, in order to guide the piston 10 during its movement.

The fixed body also comprises a connection bore 26, arranged to receive a connector 40 visible in FIG. 3. Advantageously, the fixed body 20 comprises a slot 28 (visible in FIG. 1) sized to fully receive the connector 40, such that the connector does not extend beyond. Thus, securing the fixed body 20 on a flat face of the vehicle is possible and the length of the piston is maximized.

FIG. 4 depicts the thrust member before functioning, with the piston 10 in rest position, in other words with the crimped portion 11 engaged with the projecting part 21 (the crimping interface).

FIG. 5 depicts the thrust member at the beginning of functioning, with the piston 10 just leaving the rest position thereof, in other words with the crimped portion 11 facing the projecting part 21 (the crimping interface). The igniter 30 has just functioned, has uncapped and generated gases that push the piston 30 towards the top of FIG. 5. As a result, as shown in FIG. 5, the crimped portion 11 passes above the projecting part 21 by elastic deformation of the piston 10.

FIG. 6 depicts the thrust member during operation, with the piston 10 that slides along the fixed body 20, from the rest position thereof to the deployed position. In particular, it can be noted that the crimped portion 11 slides along the thinner portion 24 in order to guide the piston 10. Indeed, due to the elastic return of the piston 10 (relative to FIG. 5), the crimped portion 11 is adjusted to the thinner portion 24 and participates in guiding the piston 10.

It will be understood that various modifications and/or improvements obvious to those skilled in the art may be made to the different embodiments of the invention described herein without going beyond the scope of the invention. In particular, reference is made to a thrust member for a pedestrian protection device, but it can be envisaged for the invention to be used for a thrust member of a safety belt retractor, or for a thrust member of an electric circuit cutoff.

1. A thrust member for a pedestrian protection device of a motor vehicle, comprising:
a fixed body (20), arranged to be fixed on the vehicle,
a piston (10), which is movable relative to the fixed body (20) between a rest position and a deployed position,
a pyrotechnic actuator, arranged to move the piston (10) from the rest position to the deployed position,
characterized in that the piston (10) is crimped to the fixed body (20) to be held in the rest position.

2. The thrust member according to the preceding claim, wherein the piston (10) crimped in the rest position comprises at least one portion of crimped wall (11), seated on a support portion of the fixed body (20) and sloped relative to a direction of movement of the piston (10).

3. The thrust member according to one of the preceding claims, wherein the piston (10) has a circumference, and wherein the piston (10) is crimped onto the whole circumference thereof or only by segments.

4. The thrust member according to one of the preceding claims, wherein the fixed body (20) comprises at least one groove, and wherein the piston (10), crimped in the rest position, comprises a wall portion arranged in the groove, following a plastic deformation.

5. The thrust member according to one of the preceding claims, wherein the fixed body (20) comprises at least one projection (21), and wherein the piston (10), crimped in the rest position, comprises a wall portion seated on the projection (21), following a plastic deformation.

6. The thrust member according to one of the preceding claims, wherein the fixed body (20) comprises:
a crimping interface, arranged to allow a crimping for retaining the piston (10) in the rest position thereof,
a stop interface, arranged to form an end-of-travel stop for the piston (10) in order to define the deployed position,
and wherein the end-of-travel stop has a clearance dimension for the piston (10) that is greater than a clearance dimension of the crimping interface.

7. The thrust member according to one of claims 1 to 4, wherein the fixed body (20) comprises:
a crimping interface, arranged to allow a crimping for retaining the piston (10) in the rest position thereof,
a stop interface, arranged to form an end-of-travel stop for the piston (10) in order to define the deployed position,
and wherein the end-of-travel stop has a clearance dimension for the piston (10) that is less than or equal to a clearance dimension of the crimping interface.

8. The thrust member according to one of claim 5 or 6, wherein the fixed body (20) comprises a thinner portion between the crimping interface and the stop interface, the thinner portion having a clearance dimension less than the clearance dimension of the crimping interface.

9. The thrust member according to one of claim 5 or 6, wherein the fixed body (20) comprises a thinner portion between the crimping interface and the stop interface, the thinner portion having a clearance dimension greater than the clearance dimension of the crimping interface.

10. The thrust member according to one of the preceding claims, wherein the fixed body (20) comprises elastic holding means arranged to engage with the piston (10) and hold it in the deployed position.

11. The thrust member according to one of the preceding claims, wherein the pyrotechnic actuator comprises a pyrotechnic igniter (30), crimped, overmolded or clipped onto the fixed body.

12. The thrust member according to one of the preceding claims, wherein the fixed body (20) comprises a base and a slot arranged in the base to form a clearance for a connection element of the pyrotechnic actuator.

13. The thrust member according to one of the preceding claims, wherein the piston (10) is formed by a shell.

14. A pedestrian protection device for a vehicle, comprising at least one thrust member according to one of the preceding claims in order to form a lift member of a hood.

15. A motor vehicle comprising at least a pedestrian protection device according to the preceding claim.

16. A thrust member for a pedestrian protection device of a motor vehicle, comprising:
a fixed body arranged to be fixed to the vehicle,
a piston, which is movable relative to the fixed body between a rest position and a deployed position,
a pyrotechnic actuator, arranged to move the piston from the rest position to the deployed position,
wherein the piston is crimped to the fixed body to be held in the rest position.

17. The thrust member according to claim 16, wherein the piston crimped in the rest position comprises at least one portion of crimped wall, seated on a support portion of the fixed body and sloped relative to a direction of movement of the piston.

18. The thrust member according to claim 16, wherein the piston has a circumference, and wherein the piston is crimped onto the whole circumference thereof or only by segments.

19. The thrust member according to claim 16, wherein the fixed body comprises at least one groove, and wherein the piston, crimped in the rest position, comprises a wall portion arranged in the groove, following a plastic deformation.

20. The thrust member according to claim 16, wherein the fixed body comprises at least one projection, and wherein the piston, crimped in the rest position, comprises a wall portion seated on the projection, following a plastic deformation.

21. The thrust member according to claim 16, wherein the fixed body comprises:
a crimping interface, arranged to allow a crimping for retaining the piston in the rest position thereof,
a stop interface, arranged to form an end-of-travel stop for the piston in order to define the deployed position,
and wherein the end-of-travel stop has a clearance dimension for the piston that is greater than a clearance dimension of the crimping interface.

22. The thrust member according to claim 16, wherein the fixed body comprises:
a crimping interface, arranged to allow a crimping for retaining the piston in the rest position thereof,
a stop interface, arranged to form an end-of-travel stop for the piston in order to define the deployed position,
and wherein the end-of-travel stop has a clearance dimension for the piston that is less than or equal to a clearance dimension of the crimping interface.

23. The thrust member according to claim 20, wherein the fixed body comprises a thinner portion between the crimping interface and the stop interface, the thinner portion having a clearance dimension less than the clearance dimension of the crimping interface.

24. The thrust member according to claim 20, wherein the fixed body comprises a thinner portion between the crimping interface and the stop interface, the thinner portion having a clearance dimension greater than the clearance dimension of the crimping interface.

25. The thrust member according to claim 16, wherein the fixed body comprises elastic holding means arranged to engage with the piston and hold it in the deployed position.

26. The thrust member according to claim 16, wherein the pyrotechnic actuator comprises a pyrotechnic, crimped, overmolded or clipped onto the fixed body.

27. The thrust member according to claim 16, wherein the fixed body comprises a base and a slot arranged in the base to form a clearance for a connection element of the pyrotechnic actuator.

28. The thrust member according to claim 16, wherein the piston is formed by a shell.

29. The thrust member according to claim 16 in combination with a pedestrian protection device for a vehicle in order to form a lift member for a hood.

30. The thrust member according to claim 16 in combination with a motor vehicle.
